(19) United States
(12) Patent Application Publication
(10) Pub. No.: US 2011/0289658 A1
(43) Pub. Date: Dec. 1, 2011

(54) Helmet

(75) Inventors: Martin Knoepfli, Winterthur (CH); Jonas Gmuer, Zurich (CH)

(73) Assignee: TECASIA AG, Winterthur (CH)

(21) Appl. No.: 13/148,207

(22) PCT Filed: Feb. 5, 2010
(86) PCT No.: PCT/EP2010/000739

§ 371 Date: Aug. 5, 2011

(30) Foreign Application Priority Data
Feb. 6, 2009 (DE) 20 2009 002 447.4

(51) Int. Cl. H05B 37/02; A42B 3/28; F21L 4/08

(52) U.S. Cl. 2/410; 315/313; 315/152; 315/294; 315/312; 362/183

(57) ABSTRACT

A helmet with an illumination device with at least one electric light source arranged on the outside of the helmet shell, a sensor for detecting the arrangement of the helmet on a head, an electric control device and an electric voltage source electrically connected with the electric light source and the sensor, wherein the electric control device is designed such that it switches on the electric light source or only permits the switching on of the electric light source when the sensor detects the arrangement of the helmet on a head.

### CROSS-REFERENCE TO RELATED APPLICATIONS

Not applicable.

### STATEMENT REGARDING FEDERALLY SPONSORED RESEARCH

Not applicable.

### BACKGROUND OF THE INVENTION

The invention relates to a helmet, which can be designed in particular as a helmet for bicyclists and/or skiers. However, the helmet can also be designed for skaters, skateboarders, snowboarders or other athletes.

Helmets with an illumination device serve for better detection of bicyclists at night or respectively in bad visibility and, if applicable, when the road is poorly lit.

U.S. Pat. No. 5,544,027 discloses an LED device, which can be attached to conventional or new bicycle helmets, in order to improve detectability in evening hours. LEDs are connected via an electric line with an electric voltage source such as a battery arranged in the helmet, or with an external voltage source, such as with a dynamo arranged on a bicycle. In one exemplary embodiment, a plurality of LEDs is arranged in series behind each other on a strip, which is fixable on a conventional helmet by means of an adhesive strip. The battery is housed in an enlarged, rectangular section on the end of the strip. This arrangement is placed outside over the crown area of the helmet, wherein the battery box on the back of the head area of the helmet is very bulky. Despite the plurality of LEDs, the visibility of the strip arranged above the crown of the wearer is not particularly good.

CA 2,227,042 A1 discloses a bicycle helmet with a device for switching on and off a series of illuminants, which comprise spaced light bulbs in a clear and flexible as well as transparent and waterproof material. The strip is attached around the outer perimeter of the helmet. The box-like battery is arranged on the outside of the helmet above the back of the head, as is the on/off switch.

This helmet provides the illumination important for the safety of the wearer of the back of the head side and the rear side areas of the helmet. However, the device is voluminous and, accordingly, the accommodation on a helmet is problematic, especially if it needs to be small and light for use during sports.

It is also disadvantageous that the known illumination devices must be switched on and off so that they are not always switched on in poor visibility conditions or remain switched on during sufficient visibility conditions and use power unnecessarily.

Furthermore, known helmets are disadvantageous in that cold air can get into the helmet shell on the head of the often sweaty wearer through ventilation slots in the helmet shell during cold weather so that the wearer runs the risk of getting a cold. As a result, a warming hat is often worn instead of a helmet.

Based on this, the object of the invention is to create a helmet that better protects the wearer.

### BRIEF SUMMARY OF THE INVENTION

The helmet according to the invention has an illumination device with at least one electric light source arranged on the outside of the helmet shell, a sensor for detecting the arrangement of the helmet on a head, an electric control device and an electric voltage source connected electrically with the electric light source and the sensor, wherein the electric control device is designed such that it switches on the electric light source or only permits the switching on of the electric light source when the sensor detects the arrangement of the helmet on a head.

The helmet according to the invention only switches on the light source when the helmet is arranged on the head of the wearer. This is detected by the sensor. The sensor delivers a corresponding signal. The control device aligns the signal depending on whether the sensor has detected the arrangement of the helmet on a head and only if this is the case does the control device switch on the electric light source. Thus, the helmet ensures that the illumination device is only switched on when the helmet is on the head of the wearer. When the helmet is removed, the illumination device is switched off. Unnecessary power consumption is hereby avoided so that the illumination device can be used more frequently when visibility conditions require it. The helmet is thus safer than conventional helmets. The invention includes embodiments in which the illumination device is always switched on when the helmet is on the head of the wearer. But it also includes embodiments in which the electric control device only enables the switching on of the electric light source when the helmet is placed on the head. An additional switch is then required to switch on the light source; in particular, this can be a switch actuatable by hand or a dimmer switch. In the case of this embodiment, a switching on of the light source and thus the associated power consumption is avoided when the helmet is taken off.

The sensor can be designed in different manners. In accordance with one embodiment, the sensor has electric contacts in two connectable closing elements of a fastener of a chinstrap, wherein electric lines connected with the contacts run along the chinstrap and are connected with the electric control device. Only when the closing elements of the fastener are joined is the light source switched on or respectively can be switched on. Since the closing elements are regularly joined when the helmet is placed on a head, this sensor detects that the helmet sits on the head of a wearer. This embodiment thus achieves that the light source is switched on or can be switched on when the helmet sits on the head of the wearer and the light source otherwise remains switched off.

In accordance with one embodiment, the sensor has a photo electric sensor with a light source and a light receiver and the optical path of the photo electric sensor runs through the space in the helmet shell for the head of the wearer. When the helmet is on the head, the optical path of the photo electric sensor is interrupted. When the helmet is not on, the sensor is illuminated by the light source. As a result the sensor determines whether or not the helmet is on a head.

In accordance with one embodiment, the sensor has a scanning organ that reaches into the space for the head so that it is actuated by the head of a wearer when he/she has the helmet on. The scanning organ is for example coupled with a mechanical switch (with electric switch contacts) or an electronic switch (e.g. a hall switch or a photo electric sensor). The switch of the sensor is in turn electrically connected with the electric control devices.

In accordance with one embodiment, the sensor comprises a heat sensor, which is assigned to the space in the helmet shell so that it detects heat radiation emitted by a head in the space in the helmet. When the head is inside, the sensor emits a corresponding signal so that the electric control device can determine by evaluating the signal delivered by the sensor that the sensor detects a head inside the helmet shell.

The helmet can have one of the aforementioned sensors or several of the aforementioned sensors in any combination.

In accordance with another embodiment, the light source and/or the sensor and/or the control device is/are arranged in at least one housing of the illumination device.

The helmet according to the invention has an illumination device with at least one electric light source arranged on the outside of the helmet shell, a brightness sensor arranged on the outside of the helmet shell, an electric control device and an electric voltage source electrically connected with the electric light source and the brightness sensor, wherein the electric control device is designed such that it controls the electric light source according to the measure of the signal delivered by the brightness sensor.

In the case of the helmet according to the invention, the electric control device controls the electric light source depending on the visibility conditions detected by the brightness sensor. The invention includes embodiments, in which the control device is designed such that the electric light source is switched on in poor visibility conditions and switched off in good visibility conditions are. It also includes embodiments, in which the control device is designed such that the electric light source is brighter the poorer the visibility conditions. However, it can also be designed such that the electric light source is less bright in complete darkness because it already stands out better from the environment. The function between the signal delivered by the electric brightness sensor and the power delivered to the electric light source can be selected according to usefulness considerations. Furthermore, the invention relates to embodiments, in which the control device is designed such that the electric light source is switched on in poor visibility conditions and switched off in good visibility conditions and also controls the brightness of the switched on electric light source depending on the visibility conditions. Furthermore, embodiments are included in which the electric control device is designed such that the electric light source can only be switched on or respectively off if this is possible based on the signal delivered by the brightness sensor. For the switching on of the electric light source, an additional switch must then be connected and, when it is open, the electric light source is switched off.

In all embodiments, the wearer is better protected by the helmet because the control of the electric light source reduces power consumption and thus increases the availability of the illumination. In the case of embodiments in which the helmet is automatically switched on in poor visibility conditions, an illumination is ensured in poor visibility conditions.

In accordance with one embodiment, the light source is then only switched on or can be switched on when the helmet is on the head of the wearer.

In accordance with another embodiment, the electric control device is designed to switch on the light source if the signal output by the brightness sensor falls below a certain threshold value for a defined period of time and/or to switch off the light source if the signal output by the brightness sensor exceeds another threshold value for another defined period of time. An undesired reaction of the illumination device to a short-term fluctuation in the ambient brightness is hereby avoided.

In accordance with one embodiment, the defined period of time and/or the other defined period of time is at least five and/or at most 30 seconds.

The helmet according to the invention has an illumination device with at least one electric light source comprising a light conductor arranged on the outside of the helmet shell with strip-like structures extended diagonal to its longitudinal direction and/or a dim light-conducting material and an LED on at least one end of the light conductor and an electric voltage source.

In the case of the illumination device, the LED emits light into one end of the light conductor. The light conductor emits the light due to its strip-like structures and/or due to its dim light-conducting material diagonal to its longitudinal direction. This is based on the fact that the light is deflected from the strip-like structures and/or from tiny light-dispersing particles embedded in the material of the light conductor and dimming it diagonal to the longitudinal direction of the light conductor. The light is emitted on the sides of the light conductor. In particular, it can be emitted on the longitudinal side of the light conductor lying opposite the strip-like structures. The illumination device thus emits light along a longitudinal side so that an overall strip-like light source is formed. A better light emission than for conventional illumination devices, which comprise more LEDs, which give off light punctually, is thereby achieved. The helmet can also have the illumination device on easily visible surfaces.

Furthermore, it is possible to combine illumination devices into one illumination device giving off light two-dimensionally.

The helmet better protects the wearer because the illumination device is more noticeable.

In accordance with one embodiment, the two-dimensionally dispersing light conductor is mounted on the outside of the helmet shell. Furthermore, it is preferably arranged on the outside of the helmet shell. In accordance with another embodiment, the light source or respectively LED with the electric contacts is permanently foamed into the helmet shell. In accordance with another embodiment, the LED with the electric contacts is embedded in the foam of the helmet shell. In accordance with another embodiment, the power supply of the light source is realized by means of the electronic unit. In accordance with another embodiment, the power supply of the light source is established via spring contacts, which are connected with cables foamed into the helmet shell. The cables are preferably embedded into the foam of the helmet shell. The spring contacts can also be at least partially embedded or respectively foamed into the foam of the helmet shell.

An electronic unit, which controls the light source or respectively LED and also comprises the electric voltage source, is preferably embedded in the helmet shell. Furthermore, it is preferably embedded in the helmet shell in a removable and flush manner. Furthermore, the electric unit is preferably removable from the inside or outside of the helmet shell.

The strip-like structures can be designed differently. In accordance with one embodiment, the strip-like structures are channels and/or projections arranged on the inside and/or outside of the light conductor.

The LED can be positioned in different manners with respect to the end of the light conductor. In accordance with one embodiment, the light conductor has a sleeve on one end, in which the LED is inserted.

In accordance with another embodiment, the helmet comprises several electric light sources each with a light conductor and an LED. The electric light sources can be arranged on different sides of the helmet, for example front and back and/or on the left or the right side of the helmet. In accordance with another embodiment, the helmet comprises two electric light sources with parallelly arranged light conductors. The parallelly arranged light conductors can emit light almost two-dimensionally. In accordance with another embodiment, neighboring parallel light sources have the LED on opposite ends. More even light emission is hereby achieved through the arrangement of several parallel light sources.

In accordance with another embodiment, parallel light sources are arranged on a common carrier, which is inserted in another receiver outside on the helmet shell. The arrangement of parallel light sources on a common carrier forms an illumination module, which is mountable as an entire unit in a helmet and facilitates the equipping or refitting of a helmet with an illumination device.

In accordance with one embodiment, at least one electric light source is arranged over the back of the head area and/or over the front scullcap area and/or over the temple area.

The helmet according to the invention has an illumination device with at least one electric light source comprising several flexible light conductors and at least one LED, wherein the light conductors are arranged with one end on the at least one LED and with the other end in different light outlet openings of the helmet shell, and an electric voltage source.

In accordance with one embodiment, the supply of the flexible light conductor can be realized with light from an electronic unit removable from the helmet can take place. It can have the LED. The electronic unit can comprise the control electronics for controlling the LED. Furthermore, it can comprise the electric voltage source. A switch for switching on the power supply and/or the LED is available according to one embodiment of the electronic unit. In contrast, the light conductors are preferably permanently foamed into the helmet shell. Furthermore, they are preferably embedded into the foam of the helmet shell.

The electronic unit is preferably fitted two-dimensionally into the helmet shell. It is also preferably fitted two-dimensionally into a helmet shell made of foam. The electronic unit is also preferably fitted flush into the helmet shell. It is also preferably flush with the inside or outside of the helmet shell. It is also preferably removable from the inside or outside of the helmet or respectively of the helmet shell.

In the case of the illumination device, one or more LEDs shine light into the ends of several flexible light conductors. The flexible light conductors are for example glass fibers, nylon threads or the like. The light conductors are arranged with their other ends in different light outlet openings of the helmet shell. As a result, the light of one or more LEDs is emitted from different light outlet openings in the helmet shell. The light outlet openings can be distributed over different sides of the helmet shell so that a light radiation from different sides of the helmet shell is achieved. The light outlet openings can be distributed evenly or unevenly over the entire helmet shell or over one part of the same. It is also possible to arrange one or more light outlet openings in subareas of the helmet shell close to each other. Several of such subareas can be arranged at greater distances from each other. The invention enables light radiation from different spots on the helmet shell using just one single LED. In the case of the use of several LEDs, it enables light radiation from a number of light outlet openings, which exceeds the number of LEDs. The helmet contributes to the safety of the wearer through the improved light emission.

Several LEDs can be the same or different colors. In the case of the use of several different colored LEDs, the different colors can be assigned to different sides of the helmet on which the light outlet openings are arranged, which are connected with the respective LEDs of a certain color via light conductors. For example, light conductors, which open into the light outlet openings on the front side of the helmet, can be guided to one or more white LEDs so that white light is emitted from the front side of the helmet. Furthermore, light conductors opening into light outlet openings on the back side of the helmet can be guided to one or more red LEDs so that red light is emitted from the back side of the helmet.

The helmet according to the invention can have the characteristics of at least one additional helmet according to the invention and, if applicable, of its embodiments.

The light conductors can generally be guided along on the outside of the helmet shell. In accordance with a preferred embodiment, the light conductors are arranged between their ends within the helmet shell. The light conductors can be embedded in the helmet shell and/or be guided along the inside of the helmet shell. On the inside of the helmet shell, they can be covered by an interior lining of the helmet shell.

The LED can generally be arranged on the outside of the helmet shell along a light outlet opening of the helmet shell so that the LED emits light additionally directly to the outside. In accordance with another embodiment, the LED is arranged within the helmet shell. The light is then directed exclusively outward via light conductors. An even light emission can hereby be achieved via all light outlet openings.

The light conductors can be fixed in different manners with their ends on the light outlet openings. For example, they can be pressed and/or glued into light outlet openings. In accordance with one embodiment, the light conductors have broadenings arranged on the light outlet openings outside on the helmet shell. Through the broadenings, the light conductors are secured at their positions in the light outlet openings. At an egression from the light outlet openings, they can also be secured through a suitable embedding or respectively fixing within the helmet shell, for example through gluing in and/or clamping into a channel of the helmet shell. Furthermore, the broadenings can serve to enlarge the light radiating surface and/or to radiate the light outward at a greater radiation angle. For this, the broadening is raised-head-like in accordance with another embodiment.

The broadenings of the LED can be produced for example through the pressing wide of the ends of the light conductors made of plastic or another heat malleable material by means of a hot tool.

It is understood that in all exemplary embodiments the electric voltage source is connected or can be connected with the electric light source. The electric switch and/or the electric control device serves to connect the electric voltage source with the electric light source.

In accordance with another embodiment, the electric voltage source comprises at least one battery and/or rechargeable battery. This embodiment can be used in all inventions and if applicable their embodiments.

The helmet according to the invention with an illumination device has at least one electric light source arranged on the outside of the helmet shell, at least one rechargeable battery and at least one solar power source arranged on the outside of the helmet shell, which is connected electrically with the rechargeable battery.

In the case of the helmet according to the invention, the rechargeable battery is recharged by means of the solar power source when the helmet is illuminated. This is typically the case when using the helmet on sunny days. The helmet can be placed in a sunny location to recharge the rechargeable battery, for example on a windowsill. When using the helmet during poor visibility conditions, the rechargeable battery powers the electric light source. The operational readiness of the electric light source is increased in that the electric power supply of the helmet is recharged again. The safety of the helmet wearer is hereby increased.

The helmet according to the invention can advantageously have the characteristics of one or more of the other inventions and if applicable their embodiments.

The helmet according to the invention has a helmet shell with parallel ventilation slots and two bezels with congruent other ventilation slots near the ventilation slots of the helmet shell, which are guided displaceably in the helmet shell in the longitudinal direction and diagonal to the ventilation slots and each have a guide slot, wherein the guide slots of the two bezels are tilted opposite the ventilation slots and the bezels each have another guide slot, which runs parallel to the ventilation slots and guide pin engaging in all guide slots is displaceable in another guide slot of the helmet shell, which is extended parallel to the ventilation slots.

In the case of helmets according to the invention, the two bezels are displaced through displacement of the guide pin in another guide slot so that the other ventilation slots of the bezels more or less overlap the ventilation slots of the helmet shell. Thus, the cross-section of the ventilation slots on the helmet is adjustable and thus the quantity of the air let through the ventilation slots. In the case of low ambient temperatures, the ventilation slots can be completely or almost completely closed and can be completely or almost completely opened in the case of high ambient temperatures. In the case of medium temperatures, the ventilation slots and the other ventilation slots can be brought to overlap by approximately half. As a result, the helmet enables an adjustment for the respective ambient conditions. The wearing of the helmet is thus more comfortable than with conventional helmets, in which the ventilation slots are not changeable. As a result, a user uses the helmet for frequently and the helmet increases the safety of the wearer.

The helmet according to the invention can have the characteristics of at least one additional helmet according to the invention and if applicable of its embodiments.

### BRIEF DESCRIPTION OF THE SEVERAL VIEWS OF THE DRAWINGS

The invention is explained in greater detail below using the attached drawings of exemplary embodiments. The drawings shown in:

FIG. 1 a helmet with an illumination device and wear recognition by means of electrical contacts in a vertical cross-section;

FIG. 2 a helmet with an illumination device and wear recognition by means of a photo electric sensor in a vertical cross-section;

FIG. 3 a helmet with an illumination device and wear recognition by means of a scanning organ in a vertical cross-section;

FIG. 4 a helmet with illumination devices and wear recognition by means of a heat sensor in a vertical cross-section;

FIG. 5 a light source with light conductor and LED of an illumination device of a helmet in a partial perspective view diagonally from the top and from the side;

FIG. 6 the same light source in a reduced, partial top view;

FIG. 7 a helmet with illumination device comprising several light sources according to FIGS. 5 and 6 in a vertical cross-section;

FIG. 8 the same helmet in a perspective view diagonally from behind and from the side;

FIG. 9 a helmet with illumination device with several parallel light sources summarized into one module in a vertical cross-section;

FIG. 10 the same helmet in a perspective view diagonally from behind and from the side;

FIG. 11 the module of the helmet from FIGS. 9 and 10 in a front view;

FIG. 12 ventilation device of a helmet with adjustable ventilation slots in a closed position in a top view;

FIG. 13 the same ventilation device in an open position in a top view,

FIG. 14 a helmet with illumination device with several flexible light conductors in a vertical cross-section.

### DETAILED DESCRIPTION OF THE INVENTION

While this invention may be embodied in many different forms, there are described in detail herein a specific preferred embodiment of the invention. This description is an exemplification of the principles of the invention and is not intended to limit the invention to the particular embodiment illustrated

In the case of the following explanation of different exemplary embodiments, corresponding parts are provided with the same reference numbers. The words “top,” “bottom,” “front” and “back” as well as “horizontal” and “vertical” refer to a helmet, which is worn by a person in an upright body position gazing forward towards the horizon.

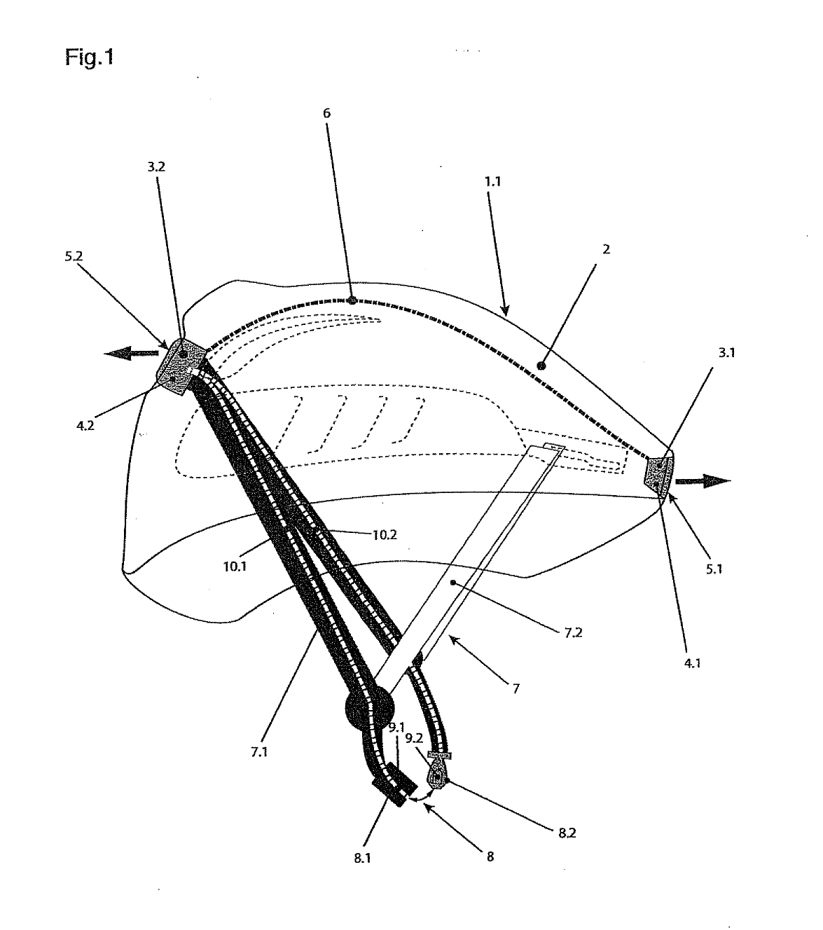

According to FIG. 1, a helmet 11 has a helmet shell 2. An illumination device 3, which comprises a front light 3.1 on the front edge of the helmet shell 2, which is arranged above the forehead, is inserted into the helmet shell 2.

Furthermore, the illumination device 3 comprises a rear light 3.2, which is arranged on the back of the helmet shell 2 above the occiput of the wearer. The front light 3.1 and the rear light 3.2 each have a cylindrical or truncated conical housing 4.1, 4.2, which contains a light source 5.1, 5.2 in an outer front side. The housings 4.1, 4.2 are inserted into the helmet shell 2, wherein the outer front sides with the light sources 5.1, 5.2 are arranged flush with the outside of the helmet shell 2.

The housing 4.1 contains in addition to the light source 5.2 an electric control device and an electric voltage source in the form of at least one coin cell or battery.

The front light 3.1 and the rear light 3.2 are interconnected by a two-core electric connection line 6.

The housing 4.2 has on the inner front side an eyelet, through which chinstrap 7 is passed through with a rear loop 7.1.

A front loop 7.2 of the chinstrap 7 is anchored above the front scullcap in the helmet shell 2.

The rear loop 7.1 is on the bottom ends a fastener 8 with connectable and separable closing elements 8.1, 8.2. The closing elements 8.1, 8.2 each have electrical contacts 9.1, 9.2, which come in contact with each other when the fastener is connected. The electric contacts 9.1, 9.2 are connected with electric lines 10.1, 10.2, which are integrated into the rear loop 7.1 of the chinstrap 7. The electrical lines 10.1, 10.2 are connected with the electric control device in the rear light 3.2.

Only when fastener 8 is closed and the contacts 9.1, 9.2 are in contact with each other, the electric control device enables the switching on of the light sources 5.1. 5.2. The light sources 5.1, 5.2 are switched on and off by means of an additional electric switch, which is not shown. This additional switch is for example a dimmer switch or a mechanical switch. But it is also generally possible that the illumination device is always switched on when the fastener is closed.

The helmet 1.1 thus avoids an unwanted switching on of the illumination when the helmet is not worn.

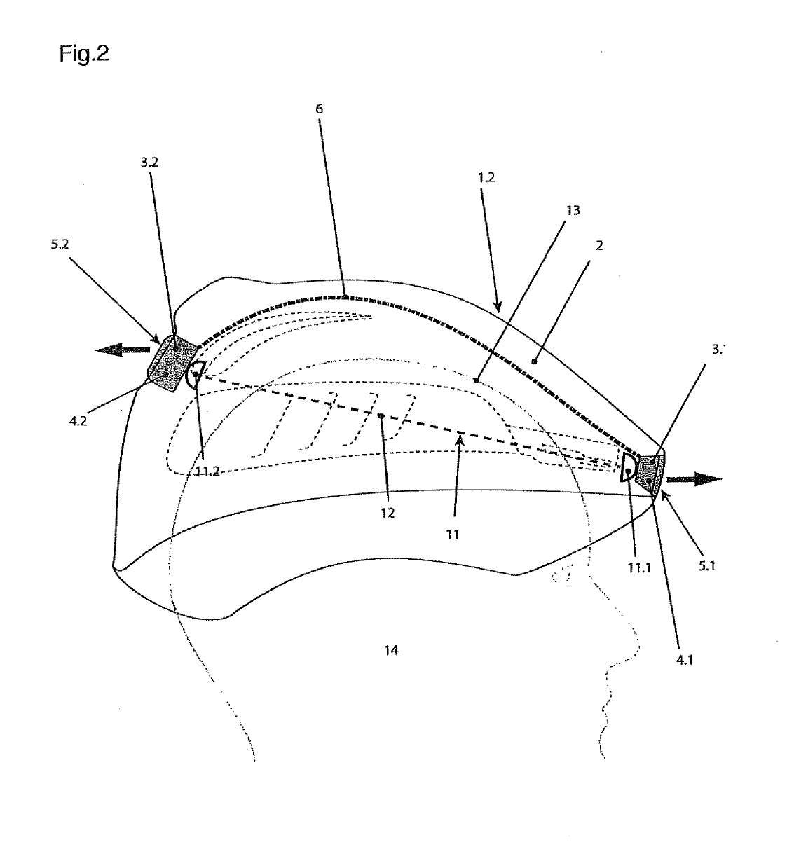

The helmet 1.2 in FIG. 2 is different from the helmet 1.2 through the design of the wear detection. For wear detection, the helmet 1.2 has a photo electric sensor 11, which has a light transmitter 11.1 on the inner front side of the housing 4.1 and a light receiver 11.2 on the inner front side of the housing 4.2 or vice versa. The light transmitter 11.1 is also connected via the connection line 6 with the electric control device in the rear light 3.2. The light receiver 11.2 is also connected to the electric control device.

The optical path 12 of the photo electric sensor 11 runs through the space 13 in the helmet shell 2 for the head 14 of a wearer.

When the helmet 1.2 is on the head 14, the optical path 12 is interrupted. The electric control device then detects that the helmet 1.2 is on and activates the light sources 5.1, 5.2. The light sources 5.1, 5.2 can then always be switched on when the optical path is interrupted. However, the switching on of the electric light sources 5.1, 5.2 can also be made depending on the additional actuation of a switch, which is for example a dimmer switch or a mechanical switch. This wear detection also avoids a switching on when the helmet 1.2 is not on.

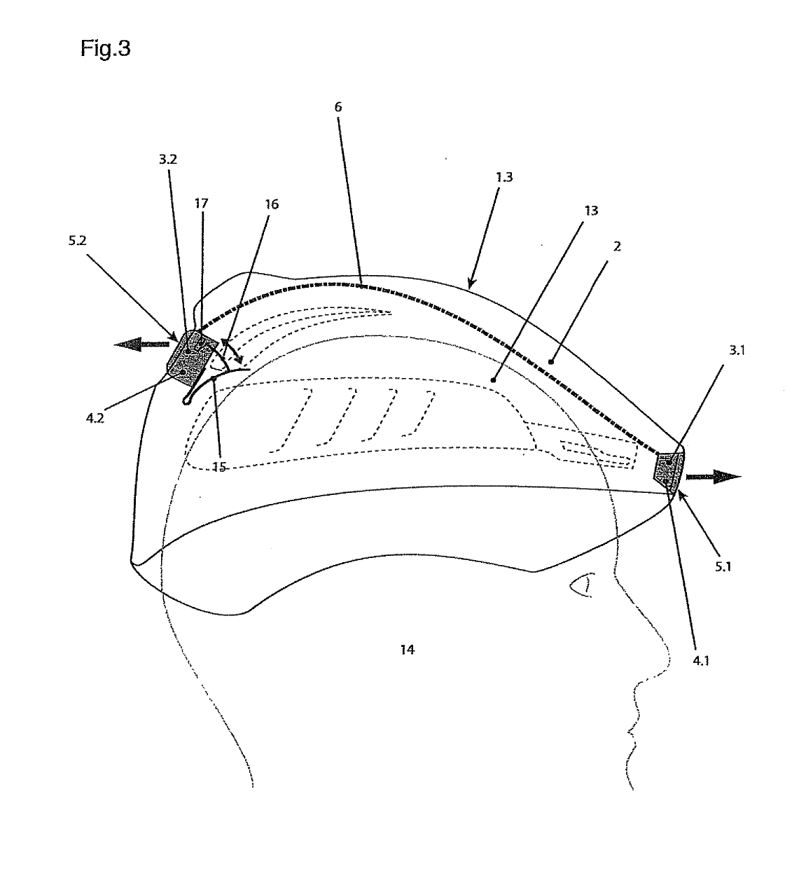

The helmet 1.3 according to FIG. 3 differs from the helmet 1.1 in that on the inner front side of the housing 4.2 of the rear light 3.2 a scanning organ 15 in the form of a bending spring is arranged, which in the unloaded state extends into the space 13 for the head 14 of the wearer. The scanning organ 15 has a pin 16 on the side facing away from the space 13, which is aligned towards an electric switch 17 in the rear housing 4.2.

When the helmet 1.3 is on the head 14, the scanning organ 15 of head 14 is pivoted closer towards housing 4.2 and the pin 16 actuates the switch 17. As a result, the control device electrically connected with the switch 17 detects that the helmet 1.3 is worn and activates the light sources 5.1, 5.2. The light sources 5.1, 5.2 are switched on in the already described manner.

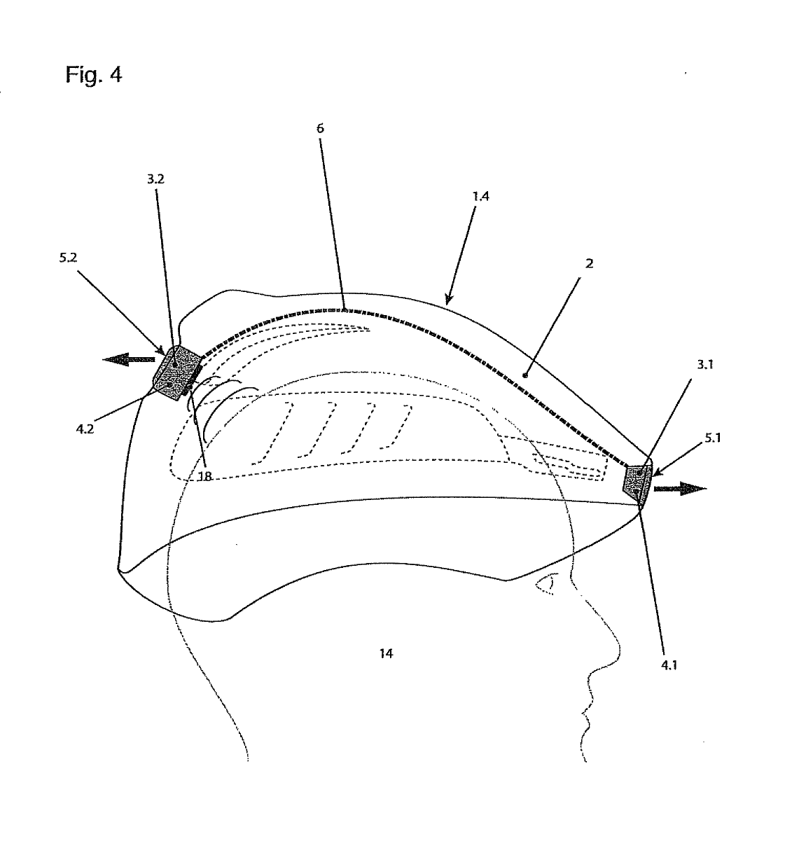

The helmet 1.4 from FIG. 4 is different from the helmet 1.1 in that a heat sensor 18 is arranged on the inner front side of the rear housing 4.2. The heat sensor 18 is electrically connected with the electric control device.

When the helmet 1.4 is on a head 14, the body temperature of the wearer acts on the heat sensor 18. Accordingly, the signal delivered by the heat sensor 18 changes in the characteristic manner. The control device detects this and activates the light sources 5.1, 5.2. As a result, the light sources 5.1, 5.2 are switched on in the already described manner.

In the exemplary embodiments described above, individual or several LEDs are arranged as light sources 5.1, 5.2 in the outer front sides of the housings 4.1, 4.2.

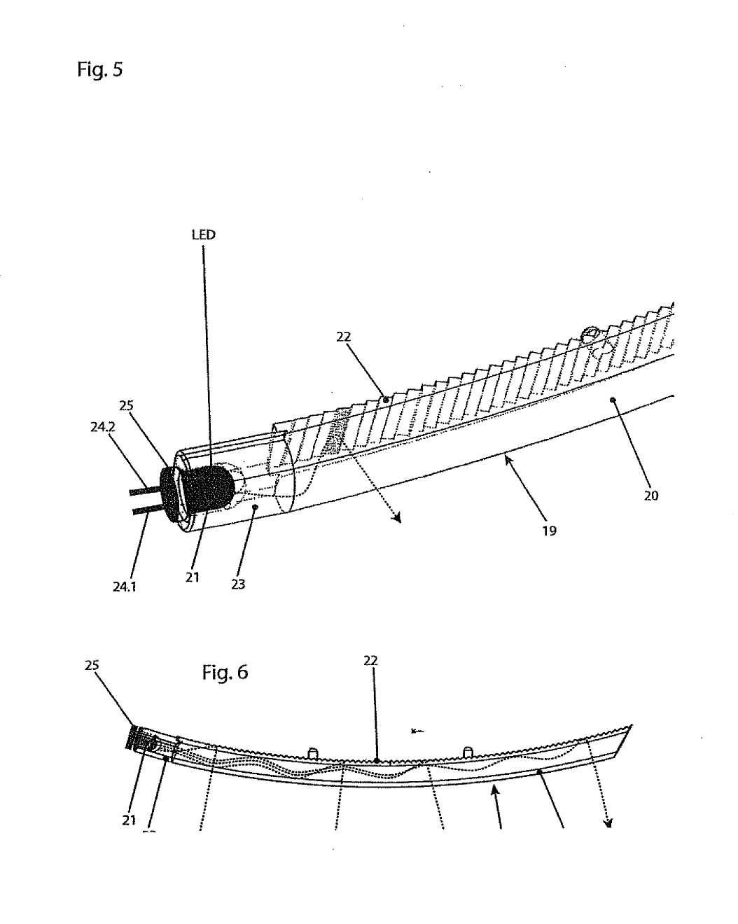

FIGS. 5 and 6 show an electric light source 19 of another helmet according to the invention, which comprises a light conductor 20 and an LED 21. The light conductor 20 has an approximately semi-circular cross-section. On the flat side of the light conductor 20, strip-like structures in the form of a plurality of parallel channels 22 are arranged diagonal to its longitudinal direction. On one end, the light conductor 20 has a sleeve 23, into which the LED 21 is pressed with its transparent embedding. The two electric contacts 24.1, 24.2 of the LED 21 protrude from the sleeve 23. The ridge-like protruding base 25 of the LED lies on the front side of the sleeve 23.

Light emitted from the LED 21 is directed from the end with the sleeve 23 in the longitudinal direction of the light conductor 19. Light portions that hit the strip-like structures 22 are reflected diagonal to the broadening direction and exit from the side of the light conductor 20, which lies opposite the side with the strip-like structures 22. As a result, an even radiation of the light emitted by the LED 21 is achieved over the entire length of the light conductor 20.

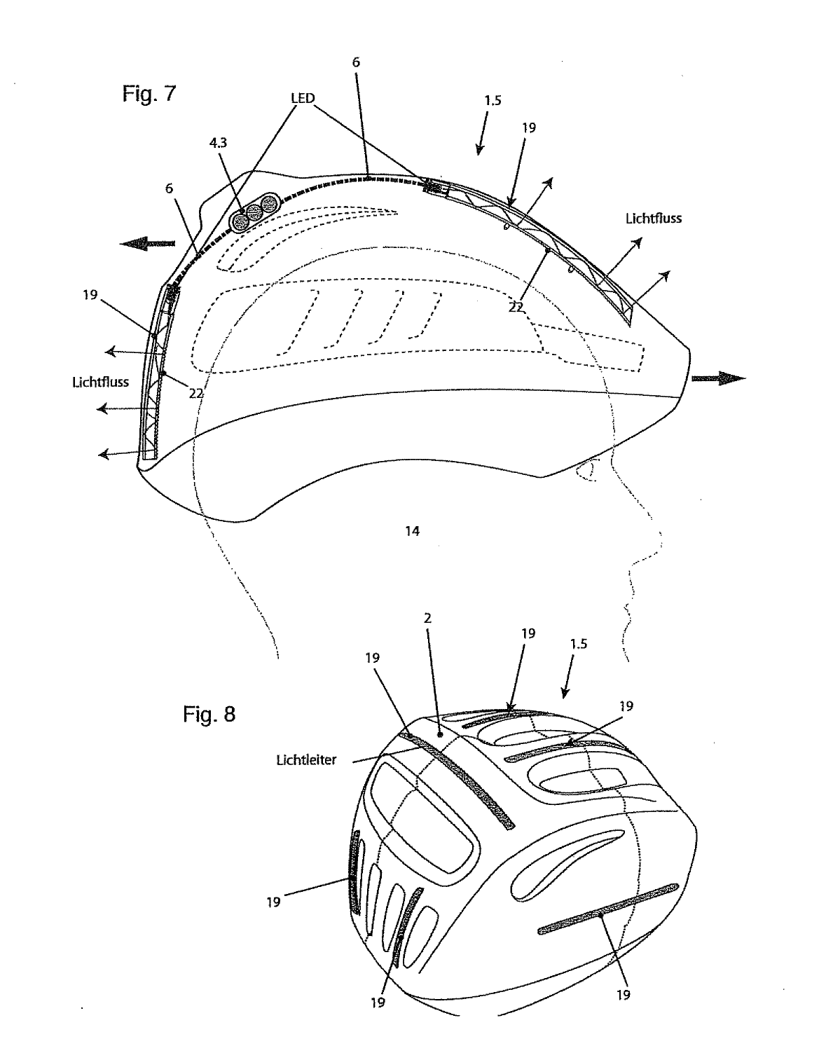

According to FIGS. 7 and 8, several light sources 19 are arranged on a helmet 1.5. The light sources 19 are each integrated into the helmet shell 2, wherein its light-emitting outside is flush with the outside of the helmet shell 2. The light sources 19 are arranged above the scullcap area, above the temple area and diagonally above the occiput as well as vertically above the back of the head. All light sources 19 are connected with an electric power supply in the form of coin cells or batteries in a central housing 4.3 via electric connection cables 6. Furthermore, the electric illumination device comprises devices for switching the light sources 19 on and off (not shown). Additionally, wear detections can be present according to the exemplary embodiments in FIG. 1 through 4.

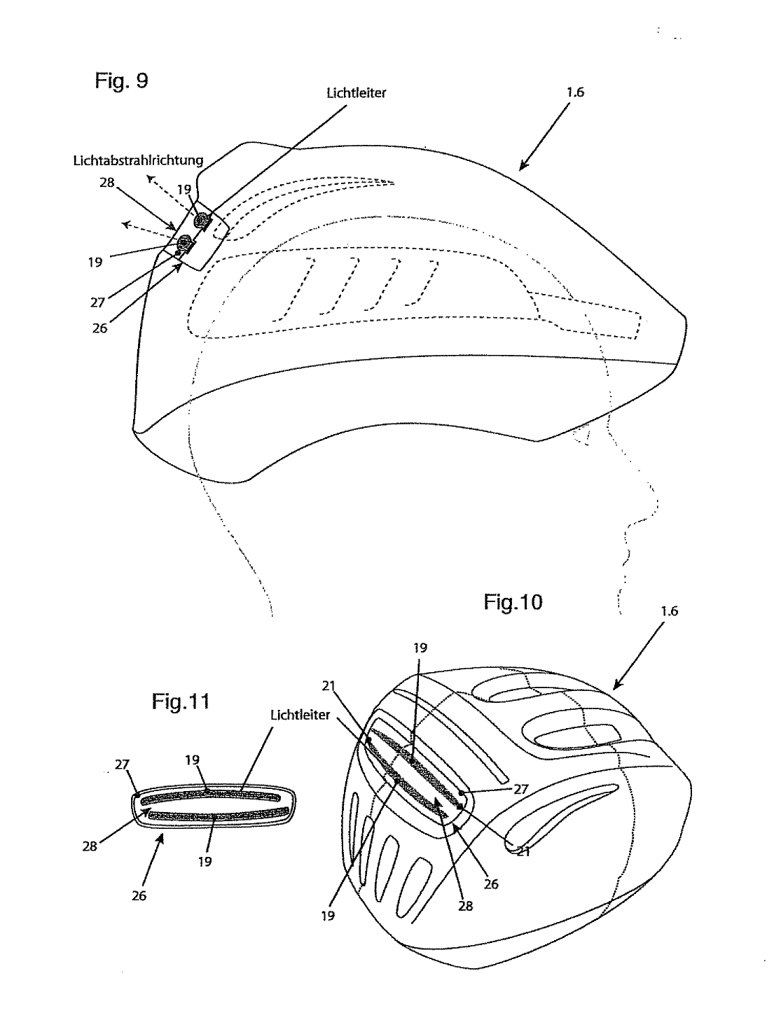

According to FIGS. 9 and 10, a helmet 1.6 has a module 26, which comprises a housing 27, in which two light conductors 19 are arranged mainly parallel. The light conductors 19 have the LED 21 on oppositely directed ends. The module 26 enables a simple mountability through insertion or respectively snapping in of the housing 27 into the helmet shell 2, for which housing 27 and helmet shell 2 can be provided with suitable snapping means. Furthermore, the module 26 is an almost two-dimensional light radiation since the light-emitting surface of the light conductor 19 forms a large part of the light-emitting surface of the module 26. The light-emitting surface can be formed by a covering 28 of the housing 27 dispersing the light (see FIG. 11).

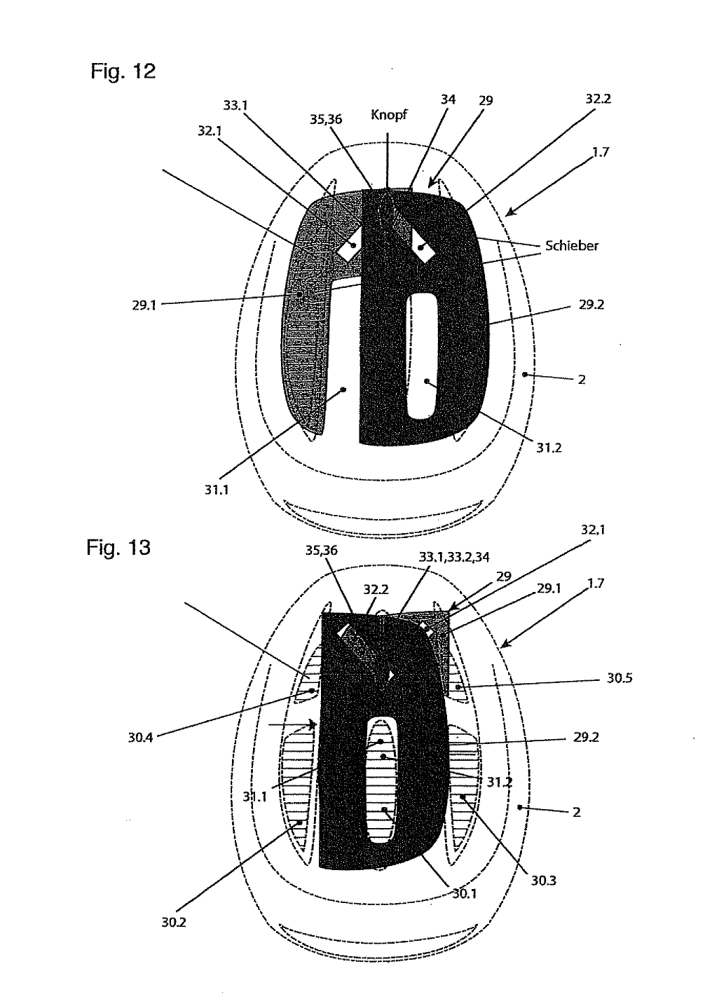

FIGS. 12 and 13 show a ventilation device 29 on a helmet 1.7 shown with dashed and dotted lines. The helmet 1.7 has a group of parallel ventilation slots 30, which extend from the front to the back, on the top side. An elongated middle ventilation slot 30.1 is arranged above the crown. Lateral ventilation slots 30.2 and 30.3 are arranged on both sides of the middle ventilation slot 30.1. The aforementioned ventilation slots 30.1 through 30.3 extend approximately from the middle of the helmet 1.7 over the occiput.

In front of the ventilation slots 30.2, 30.3, additional ventilation slots 30.4, 30.5 are present, which extend further over the front area of the helmet shell. The ventilation device 29 comprises two bezels 29.1, 29.2, each of which are provided with additional ventilation slots 31.1, 31.2, which extend from front to back. Furthermore, the bezels 29.1, 29.2 each have a guide slot 32.1, 32.2, which is tilted diagonal to the ventilation slots 30.1 through 30.5 and the other ventilation slots 31.1 through 31.2. In the front, the guide slots 32.1, 32.2 are each connected with another guide slot 33.1, 33.2 in the bezels 29.1, 29.2, which run parallel to the ventilation slots 30.1 through 30.5 or respectively 31.1 through 31.2.

Another guide slot 34, which overlaps the other guide slots 33.1, 33.2, is present in the helmet shell 2.

A guide pin 35 is inserted into the guide slots 32.1, 32.2 and the other guide slots 33.1, 33.2 as well as 34. It is provided with a button 36 on the outside of the helmet shell 2.

The bezels 29.1, 29.2 are additionally guided to the helmet shell 2 in a direction diagonal to the other guide slots 33.1, 33.2 and 34.

The bezels 29.1, 29.2 are preferably arranged between the helmet shell 2 and an interior lining of the helmet shell 2, which has slots congruent with the slots 30.1 through 30.5.

When the button 36 is arranged in the position in FIG. 12, the guide pin 35 is located at the front end of the additional guide slots 33.1, 33.2 and 36 and on the front ends of the guide slots 32.1, 32.2. As a result, the bezels 29.1, 29.2 are maximally pulled apart and overlap the ventilation slots 30.1 through 30.5. A ventilation of the inner space of the helmet 1.7 is hereby suppressed. This position makes sense in particular on cold winter days when cold air should not be directed to the head of the wearer.

According to FIG. 13, the button 36 is pushed backwards so that the guide pin 35 is arranged on the back ends of the other guide slots 33.1, 33.2 and 34 and the guide slots 32.1, 32.2. As a result, the bezels 29.1, 29.2 are pushed together so that they mainly overlap. The openings 30.1 through 30.5 are hereby cleared. Thereby, the other ventilation openings 31.1, 31.2 overlap the ventilation opening 30.1 and the bezels 29.1, 29.2 are pulled away from the ventilation openings 30.2 through 30.5. This position, in which the ventilation openings 30.1 through 30.5 are maximally opened, is particularly advantageous on hot summer days.

The bezels 29.1, 29.2 can be brought into any intermediate positions between the positions shown in FIGS. 12 and 13 in order to regulate air flowing into the helmet shell 2 through the ventilation openings 30.1 through 30.5.

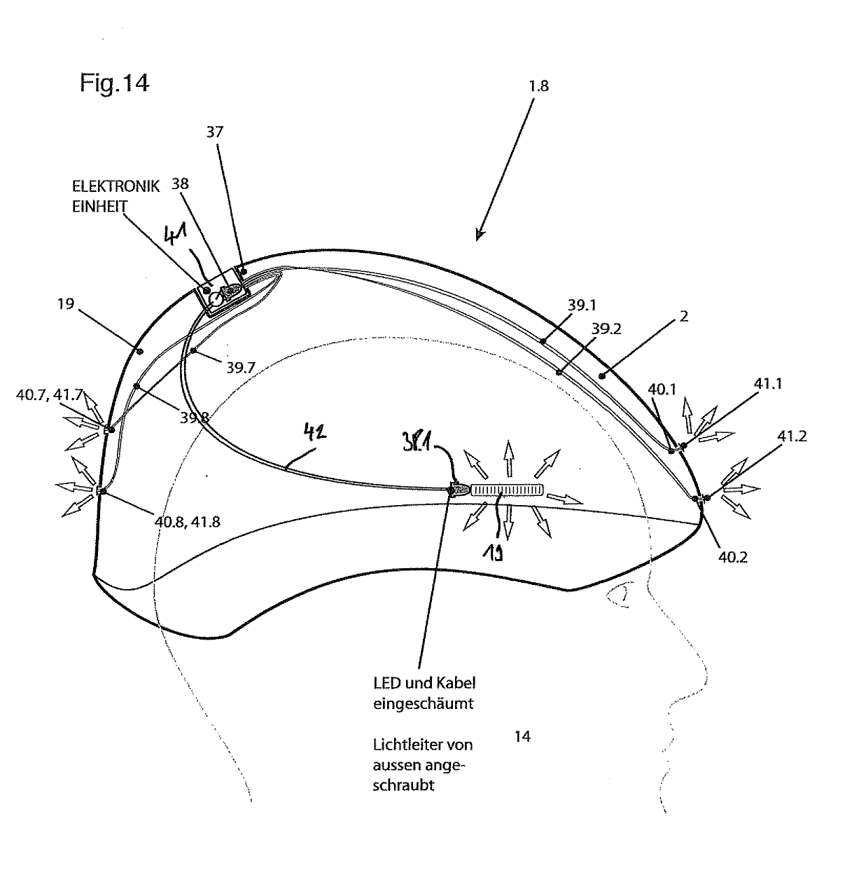

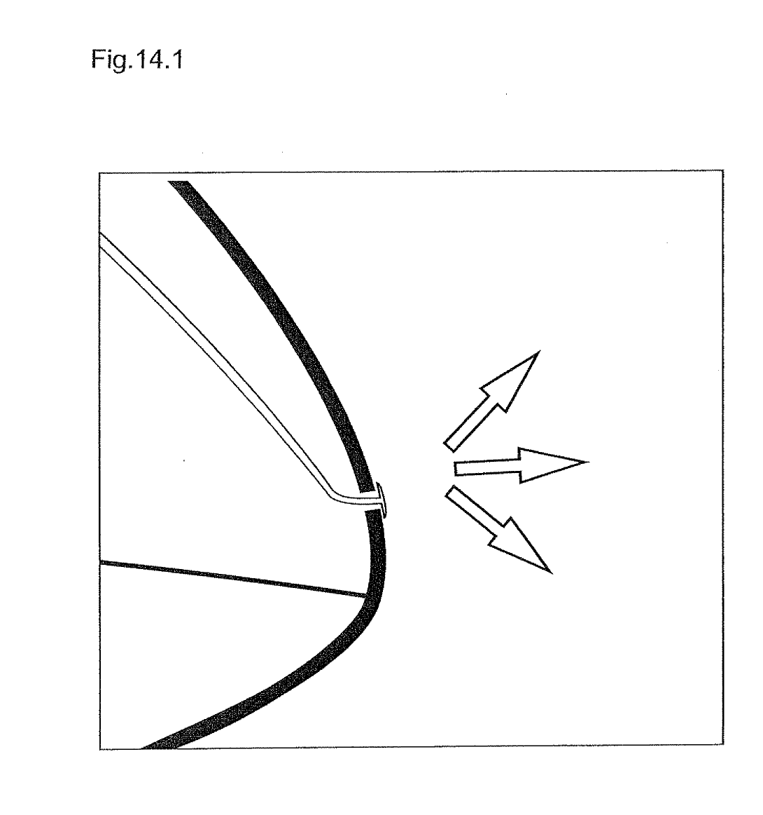

According to FIG. 14, a helmet 1.8 has a helmet shell 2, into which a small housing 37 is embedded, which contains an electric light source in the form of an LED 38. A plurality of flexible light conductors 39.1, 39.2, etc., each of which are assigned to one end of the LED 38, are inserted into the housing 37. The light conductors 39.1, 39.2, etc. are embedded into the helmet shell 2 and leave with their other end through a light outlet opening 40.1, 40.2, etc. in the helmet shell 2. Outside of the helmet shell 2, they have raised-head-like broadenings 41.1, 41.2, etc., which can also be considerably more pronounced than shown in FIG. 14. In the case of light conductors 39.1, 39.2, etc., the broadening 41.1, 41.2, etc. is made of a heat-malleable plastic through processing with a hot tool. The helmet shell 2 can have on the outside a coating e.g. made of polycarbonate or polyvinyl chloride, through which the light outlet openings 40.1, 40.2, etc. pass.

The light outlet openings 40.1, 40.2 are combined in several groups, wherein one group is arranged on the front side of the helmet shell 2 above the forehead, another group on the back side of the helmet shell 2 above the occiput and two other groups on the two sides above the temple of the wearer 14.

The housing 37 also contains an electronic unit 41 for controlling the LED 38. The housing 37 can also contain a power supply. It is inserted flush in the helmet shell 2 and can be removed or respectively inserted from the outside of the helmet shell 2. The electronic unit 41 is also connected via another LED 38.1 via cable 42, which is coupled with a light conductor 19, which is arranged on the outside of the helmet shell 2. The cable 42 and the LED 38.1 are embedded in the helmet shell 2. One or more cables 42 with LED 38.1 and light conductor 19 can be present in addition to the flexible light conductors 39.1, 39.2, etc. or instead of it.

The LEDs 38, 38.1 are connected with an electric power supply (not shown) via electric control units (not shown).

When LED 38 is switched on, the light conductor 39.1, 39.2, etc. emit light outward through the different light outlet openings 40.1, 40.2, etc. Due to the raised-head-like broadenings 41.1, 41.2, etc., the light is emitted at a large exit angle and is thus easily visible although the light conductors 39.1, 39.2, etc. are supplied from one single light source 38.

The LED 38.1 radiates via the light conductor 19.

This completes the description of the preferred and alternate embodiments of the invention. Those skilled in the art may recognize other equivalents to the specific embodiment described herein which equivalents are intended to be encompassed by the claims attached hereto.

1. A helmet with an illumination device (3) with at least one electric light source (5.1, 5.2) arranged on the outside of the helmet shell, a sensor (9.1, 9.2; 11; 18) for detecting the arrangement of the helmet (1) on a head, an electric control device and an electric voltage source electrically connected with the electric light source (5.1, 9.2; 11; 15; 18) and the sensor (9.1, 9.2; 11; 15; 18), wherein the electric control device is designed such that it switches on the electric light source or only permits the switching on of the electric light source when the sensor detects the arrangement of the helmet (1) on a head (5.1, 5.2).

2. The helmet according to claim 1, in which the sensor comprises electric contacts (9.1, 9.2) in two joinable closing elements (8.1, 8.2) of a fastener (8), wherein electric lines (10.1, 10.2) connected with the contacts run along the chinstrap (7) and are connected with the electric control device.

3. The helmet according to claim 1, wherein the sensor comprises a photo electric sensor (11) with a light source (11.1) and a light receiver (11.2) and the optical path (12) of the photo electric sensor runs through the space (13) in the helmet shell (2) for the head (14) of the wearer.

4. The helmet according to claim 1, in which the sensor comprises a scanning organ (15) that engages in the space (13) in the helmet shell (2) for the head (14) of a wearer.

5. The helmet according to claim 1, in which the sensor comprises a heat sensor (18), which is assigned to the space (13) in the helmet shell (2) so that it detects heat radiation emitted by a head (14) in the space (13).

6. The helmet according to claim 1, in which the light source (5.1, 5.2) and/or the sensor (9.1, 9.2; 11; 15; 18) and/or the control device is arranged in or on at least one housing (4.1, 4.2) of the illumination device (3).

7. A helmet with an illumination device (3) with at least one electric light source (5.1, 5.2) arranged on the outside of the helmet shell (2), a brightness sensor arranged on the outside of the helmet shell (2), an electric control device electrically connected with the electric light source (5.1, 5.2) and the brightness sensor and an electric voltage source, wherein the electric control device is designed such that it controls the electric light source according to the measure of the signal delivered by the brightness sensor.

8. (canceled)

9. The helmet according to claim 7, in which the electric control device is designed to switch on the light source (5.1, 5.2) if the signal output by the brightness sensor falls below a certain threshold value for a defined period of time and/or to switch off the light source if the signal output by the brightness sensor exceeds another threshold value for another defined period of time.

10. The helmet according to claim 9, in which the defined period of time and/or another defined period of time are at least 5 and at most 15 seconds.

11. A helmet with an illumination device with at least one electric light source (19) comprising a light conductor (20) arranged on the outside of the helmet shell (2) with strip-like structures (22) extended diagonal to its longitudinal direction and/or a dim light-conducting material and an LED (21) on at least one end of the light conductor (20) and an electric voltage source.

12. (canceled)

13. The helmet according to claim 11, in which the strip-like structures (22) are channels and/or projections arranged on the inside and/or outside of the light conductor (20).

14. The helmet according to claim 13, in which the light conductor (20) has a sleeve (23) on one end, in which the LED (21) is held.

15. The helmet according to claim 11, which comprises several electric light sources (19) each with one light conductor (20) and one LED (21).

16. The helmet according to claim 15, which comprises at least two electric light sources (19) with parallelly arranged light conductors (20).

17. The helmet according to claim 16, in which neighboring parallel light sources (19) have the LED (21) on opposite ends.

18. The helmet according to claim 16, in which parallel light sources (19) are arranged on a common carrier (27), which is inserted into another receiver outside on the helmet shell (1.6).

19. The helmet according to claim 1, on which at least one electric light source (19) is arranged above the back of the head area and/or above the front scullcap area and/or above the temple area.

20. A helmet with an illumination device with at least one electric light source comprising several flexible light conductors and at least one LED, wherein the light conductors are arranged with one end on the at least one LED and with the other ends in different light outlet openings of the helmet shell, and an electric voltage source.

21. (canceled)

22. The helmet according to claim 20, in which light conductors are arranged between their ends within the helmet shell.

23. The helmet according to claim 20, in which the at least one LED is arranged within the helmet shell.

24. The helmet according to claim 20, in which the light conductors have broadenings arranged on the light outlet openings outside on the helmet shell.

25. The helmet according to claim 24, in which the broadenings are raised-head-like.

26. The helmet according to claim 1, in which the electric voltage source comprises at least one battery and/or rechargeable battery.

27. The helmet with an illumination device (3) with at least one electric light source arranged on the outside of the helmet shell (2), at least one rechargeable battery and at least one solar power source arranged on the outside of the helmet shell, which is connected electrically with the rechargeable battery.

28. (canceled)

29. A helmet with a helmet shell (2) with parallel ventilation slots (30) and two bezels (29) with other ventilation slots (31) almost congruent with the ventilation slots (30) of the helmet shell, which are guided displaceably in the helmet shell (2) in the longitudinal direction and diagonal to the ventilation slots (30) and each have a guide slot (32), wherein the guide slots (32) of the two bezels (29) are tilted opposite the ventilation slots (30) and the bezels (29) each have another guide slot (33), which runs parallel to the ventilation slots (30) and guide pin (35) engaging in all guide slots is displaceable in another guide slot (34) of the helmet shell (2), which is extended parallel to the ventilation slots (30).

30. (canceled)

31. A helmet including a helmet shell (2), said helmet having an illumination device with at least one electric rear light (3.2) which is arranged on the back of the helmet shell (2) above the occiput of the wearer, the rear light (3.2) having a housing (4.2) which contains a light source (5.2), the housing (4.2) being inserted into the helmet shell (2) and the housing (4.2) having on the inner front side an eyelet, through which a chin strap (7) is passed through with a rear loop (7.1).

32. The helmet according to claim 31 wherein said chin strap includes a front loop (7.2) and the front loop of the chin strap is anchored above the front skull cap or a wearer of said helmet in the helmet shell (2).
